(19) United States
(12) Patent Application Publication
(10) Pub. No.: US 2013/0082824 A1
(43) Pub. Date: Apr. 4, 2013

(54) FEEDBACK RESPONSE

(71) Applicant: Ashley Colley, Oulu (FI)

(72) Inventor: Ashley Colley, Oulu (FI)

(73) Assignee: NOKIA CORPORATION, Espoo (FI)

(21) Appl. No.: 13/250,389

(22) Filed: Sep. 30, 2011

(51) Int. Cl. G08B 5/22

(52) U.S. Cl. 340/6.1

(57) ABSTRACT

An apparatus which performs at least the following:
detect a first user input associated with a particular user interface element, the user interface element associated with performance of a particular function;
in response to detecting the first user input, provide a first feedback response, the first feedback response being separate to the performance of the associated function;
detect a second user input associated with the same particular user interface element within a predetermined period of time following detection of the first user input; and
in response to detecting the second user input, provide a second feedback response, the second feedback response being separate to the performance of the function associated with the second user input, and being different to the first feedback response.

### TECHNICAL FIELD

The present disclosure relates to the field of providing feedback response.

### BACKGROUND

Electronic devices may enable a user to interact with the device via a user interface. For example, a graphical user interface (GUI) may allow a user to enter commands by interacting with one or more icons. A user may also be able to interact with an electronic device via an interface device such as an e.g. physical keyboard. Electronic devices may allow a user to enter text, for example to compose a text message or email.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

In a first aspect, there is provided an apparatus comprising:
at least one processor; and
at least one memory including computer program code,
the at least one memory and the computer program code configured to, with the at least one processor, cause the apparatus to perform at least the following:
detect a first user input associated with a particular user interface element, the user interface element associated with performance of a particular function;
in response to detecting the first user input, provide a first feedback response, the first feedback response being separate to the performance of the associated function;
detect a second user input associated with the same particular user interface element within a predetermined period of time following detection of the first user input; and
in response to detecting the second user input, provide a second feedback response, the second feedback response being separate to the performance of the function associated with the second user input, and being different to the first feedback response.

The at least one memory and the computer program, or apparatus, may be configured to perform the function associated with the first user input and provide the separate first feedback response. The at least one memory and the computer program, or apparatus, may be configured to perform the function associated with the second user input and provide the separate second feedback response. Thus, according to the particular embodiment, the associated function may or may not be performed as well as the first or second feedback response being provided.

A function may comprise, for example, opening an application, selecting an icon or symbol, or entering a character. A character may by entered in the performance of a function by a user to compose a message, for example an SMS text message, the text part of an MMS text message, an e-mail, a document, a telephone or fax number, or to compose a filename, an address bar entry, a search entry, compose a Uniform Resource Locator (URL), or to enter text into a form on a website. A character entered in the performance of a function may comprise, for example, a textual character, a letter character (e.g. upper case letter characters, lower case letter characters, from the Roman, Greek, Arabic or Cyrillic alphabets), a graphic character (e.g. a sinograph, Japanese kana or Korean character), an emoticon, a number, a glyph or a punctuation mark.

User input may comprise tapping a key, whether a physical key on a physical keyboard or a virtual key on a virtual keyboard displayed on a touch screen. User input may also be made via single- or double-clicking a mouse button or other device button. User input may also comprise making a gesture on a touch screen, with a single or multiple fingers, which may be a tap, swipe, rotate gesture, multi-touch gesture, or other gesture made on the screen, or combination thereof. Further user inputs may also be envisaged and are within the scope of this disclosure.

The user interface element may be associated with the performance of more than one particular function. For example, a “G” key on a keyboard may be used to enter the lower case letter “g” if pressed once, and the upper-case letter “G” if pressed while the shift key is held. As another example, a virtual icon used as the user interface element, displayed on a touch-sensitive screen, may provide a different function if tapped once or twice. One tap may select the icon, and a second tap within a predetermined period of time may open an application associated with that icon. Additionally, maintaining a press on the icon, rather than tapping it, may provide a further function, such as displaying information about the icon and associated functions.

The said feedback response may be configured to be positionally or audibly associated with the user interface element. For example, the feedback response may comprise a pop-up visual response, which may be positioned over, or adjacent to, or partially overlapping, the associated user interface element. As another example, the feedback response may comprise an audio announcement of a characterising feature of the user interface element. For instance, the audio feedback response for the opening of a “Contacts” menu may be that the phrase “Contacts menu open” is recited. Another example may be that upon double clicking an icon, two click sounds are provided as an audio feedback response.

The said feedback response may comprise a combination of one or more of: a visual feedback response, an audio feedback response, a haptic feedback response or a transient feedback response.

Visual feedback may comprise the display of a pop-up, a symbol, or another image. A combination of feedback may be provided, for example, the first feedback response upon a user selecting a symbol may comprise visual feedback only, such as an image of the symbol appearing on screen, and the second (different) feedback response due to the user selecting the same symbol for a second time may comprise both visual feedback, such as an image of the symbol appearing on screen, combined with haptic feedback, such as a vibration of the apparatus.

Audio feedback may comprise an announcement of a feature related to the user interface element selected (such as reciting the letter “G” if the “G” key is pressed). Audio feedback may also announce a function performed upon a particular selection of a user interface element. For example, a single click on an icon as a first user input may cause an audio announcement as an audio feedback response such as “Icon Selected”, and a further click within a predetermined period of time as a second user input, (the first and second clicks together providing a “double click” input), may cause an audio announcement as a second different audio feedback response such as “Application Loading”. Audio feedback responses may also comprise a note of a given pitch, a click sound, a buzz sound, a tune, or other sound.

Haptic feedback may be a vibration of a given strength, duration, or pattern of vibrations. For example, a first user input (tapping a key) may cause a first haptic feedback response of a vibration of 0.5 s duration, whereas a second user input of the same user interface element (tapping the same key again) may cause a second (different) haptic feedback response of a vibration of 1.0 s, or two vibrations each of 0.5 s, or a first vibration followed by a stronger second vibration, Other haptic feedback schemes are possible.

Transient feedback responses may be provided, for example, a feedback response may be provided for a certain period of time. For example, a pop-up may appear as feedback, but only for a preset period of time, such as 0.2 s, 0.5 s, 1 s, or more. An audio feedback response may be transient in that it ends upon the recitation of a phrase such as “Key pressed twice”. A vibration provided as a haptic feedback response may have a finite duration of 0.2 s, 0.5 s, 1 s, or more. It may be envisaged that, perhaps for a less experienced user who makes user input very slowly, the transient feedback duration may be set to last for a longer period of time, such as 5 s, 10 s, or more. A very experienced user or user who can make input relatively rapidly may wish to have the duration of the transient feedback set to a shorter period of time, such as 0.2 s or 0.5 s.

The visual feedback response may be provided by a pop-up display. For example, the first feedback response provided upon a user selecting an item on screen once may be for a pop-up to appear, above and larger than the user interface element selected.

The pop-up display shown as a second (different) feedback response may be positioned as to partially overlap the pop-up display shown as a first feedback response, such that the two pop-ups are shown together as a stack. It may be imagined that two pop-ups displayed together give the appearance of two playing cards stacked upon one another, such that the top card does not completely cover the one directly below it, but is offset such that both cards are at least partially visible. In this way the second feedback response, or second pop-up, is different to the first feedback response, or first pop-up, as it appears in a different position on screen, and in this case also in a different position relative to the first pop-up and to the user interface element selected.

The visual feedback response may be displayed in a separate region of the display to the user interface elements. That is, a dedicated region of the display screen may be available for the display of feedback responses. For example, it may be envisaged that upon tapping the “6” key, the number “6” appears in this dedicated region of the display. Tapping the “6” key again may cause the numbers “66” to appear in the dedicated region of the display. Other displayed images, such as “6 twice”, “two 6's”, or the second number “6” displayed may be a different colour to the first number “6”, or the second number “6” displayed may be larger than the first number “6”, and others, are possible.

The apparatus may be a portable electronic device, a pocket computer, a laptop computer, a desktop computer, a tablet computer, a mobile phone, a smartphone, a monitor, a personal digital assistant, a watch, a digital camera, or a module for one or more of the same.

The said user input may be one or more of a tap, click, swipe, a rotate gesture, a multi-touch gesture, and an extended input having a duration exceeding a predetermined threshold. The first, second and any subsequent user inputs may or may not be the same.

The user interface element may comprise a combination of one or more of: a physical key, a virtual key, a menu item, an icon, a button, and a symbol.

The user interface element may form part of a user interface, wherein the user interface may comprise a combination of one or more of a wand, a pointing stick, a touchpad, a touch-screen, a stylus and pad, a mouse, a physical keyboard, a virtual keyboard, a joystick, a remote controller, a button, a microphone, a motion detector, a position detector, a scriber and an accelerometer. A keyboard, physical or virtual, may comprise an alphanumeric key input area, a numeric key input area, an AZERTY key input area, a QWERTY key input area or an ITU-T E.161 key input area.

The apparatus may be configured to:
detect one or more subsequent user inputs associated with the same particular user interface element within respective predetermined periods of time following detection of the previous user input; and
in response to detecting the subsequent user input, provide a subsequent feedback response, the subsequent feedback response being separate to the performance of the function associated with the subsequent user input, and being different to the immediately preceding feedback response.

In a further aspect there is a method comprising:
detecting a first user input associated with a particular user interface element, the user interface element associated with performance of a particular function;
in response to detecting the first user input, providing a first feedback response, the first feedback response being separate to the performance of the associated function;
detecting a second user input associated with the same particular user interface element within a predetermined period of time following detection of the first user input; and
in response to detecting the second user input, providing a second feedback response, the second feedback response being separate to the performance of the function associated with the second user input, and being different to the first feedback response.

In a further aspect there is an apparatus comprising:
at least one processor; and
at least one memory including computer program code,
the at least one memory and the computer program code configured to, with the at least one processor, cause the apparatus to perform at least the following:
detect a first user input associated with a particular user interface element;
in response to detecting the first user input, provide a transient first feedback response;
detect a second user input associated with the same particular user interface element within a predetermined period of time following detection of the first user input; and
in response to detecting the second user input, provide a transient second feedback response, the transient second feedback response being different to the transient first feedback response.

In a further aspect there is a method comprising
detecting a first user input associated with a particular user interface element;
in response to detecting the first user input, providing a transient first feedback response;
detecting a second user input associated with the same particular user interface element within a predetermined period of time following detection of the first user input; and
in response to detecting the second user input, providing a transient second feedback response, the transient second feedback response being different to the transient first feedback response.

In a further aspect there is provided computer program (e.g. recorded on a carrier), the computer program comprising computer code configured to
detect a first user input associated with a particular user interface element, the user interface element associated with performance of a particular function;
in response to detecting the first user input, provide a first feedback response, the first feedback response being separate to the performance of the associated function;
detect a second user input associated with the same particular user interface element within a predetermined period of time following detection of the first user input; and
in response to detecting the second user input, provide a second feedback response, the second feedback response being separate to the performance of the function associated with the second user input, and being different to the first feedback response.

In a further aspect there is provided computer program (e.g. recorded on a carrier), the computer program comprising computer code configured to
detect a first user input associated with a particular user interface element;
in response to detecting the first user input, provide a transient first feedback response;
detect a second user input associated with the same particular user interface element within a predetermined period of time following detection of the first user input; and
in response to detecting the second user input, provide a transient second feedback response, the transient second feedback response being different to the transient first feedback response.

In a further aspect there is provided an apparatus comprising:
at least one means for processing; and
at least one memory means including computer program code,
the at least one memory means and the computer program code configured to, with the at least one means for processing, cause the apparatus to perform at least the following:
detect a first user input associated with a particular user interface element, the user interface element associated with performance of a particular function;
in response to detecting the first user input, provide a first feedback response, the first feedback response being separate to the performance of the associated function;
detect a second user input associated with the same particular user interface element within a predetermined period of time following detection of the first user input; and
in response to detecting the second user input, provide a second feedback response, the second feedback response being separate to the performance of the function associated with the second user input, and being different to the first feedback response.

In a further aspect there is provided an apparatus comprising:
at least one means for processing; and
at least one memory means including computer program code,
the at least one memory means and the computer program code configured to, with the at least one means for processing, cause the apparatus to perform at least the following:
detect a first user input associated with a particular user interface element;
in response to detecting the first user input, provide a transient first feedback response;
detect a second user input associated with the same particular user interface element within a predetermined period of time following detection of the first user input; and
in response to detecting the second user input, provide a transient second feedback response, the transient second feedback response being different to the transient first feedback response.

There may be provided an apparatus comprising:
at least one processor; and
at least one memory including computer program code,
the at least one memory and the computer program code configured to, with the at least one processor, cause the apparatus to perform at least the following:
detect a first user input associated with a particular user interface element, the user interface element associated with performance of a particular function;
in response to detecting the first user input, provide a first feedback response, the first feedback response being separate to the performance of the associated function;
detect a second user input associated with the same particular user interface element, wherein the second user input satisfies a parameter trigger with respect to the first user input; and
in response to detecting the second user input, provide a second feedback response, the second feedback response being separate to the performance of the function associated with the second user input, and being different to the first feedback response.

The parameter trigger may be a predetermined parameter trigger, and may comprise one or more of:
a predetermined period of time following the first user input;
a predetermined relationship between the duration of the second user input and the duration of the first user input, such as the second user input being longer or shorter than the first user input;
a predetermined relationship between the force of the second user input and the force of the first user input, such as the force of second user input being greater than or less than the force of the first user input;
a predetermined relationship between the distance of a pointing device (such as a finger) from the user interface element when making the second user input and the first user input. For example, the distance when detecting the second user input may be greater than or less than the distance when detecting the first user input.

Any period of time disclosed herein may begin or end with an initial touch or contact, or release of, a user interface element.

It will be appreciated that any embodiments or aspects disclosed herein that involve detecting a second user input associated with the same particular user interface element within a predetermined period of time following detection of the first user input, or similar, may be equally applied to any one or more parameter triggers disclosed herein. That is, any one or more of the parameter triggers disclosed herein could be used in place of “a predetermined period of time” in any examples described in this specification.

The present disclosure includes one or more corresponding aspects, embodiments or features in isolation or in various combinations whether or not specifically stated (including claimed) in that combination or in isolation. Corresponding means for performing one or more of the discussed functions are also within the present disclosure.

Corresponding computer programs for implementing one or more of the methods disclosed are also within the present disclosure and encompassed by one or more of the described embodiments. The computer program may be stored on a storage medium (e.g. on a CD, a DVD, a memory stick or other non-transitory media). The computer program may be configured to run on the device as an application. An application may be run by the device via an operating system.

The above summary is intended to be merely exemplary and non-limiting.

### BRIEF DESCRIPTION OF THE FIGURES

A description is now given, by way of example only, with reference to the accompanying drawings, in which:—

FIG. 1 illustrates an example embodiment comprising a number of electronic components, including memory, a processor and a communication unit.

FIG. 2 illustrates an example embodiment comprising a touch-screen.

FIGS. 3a-3b depict an example embodiment of FIG. 2 showing the selection of a virtual key twice and with visual feedback provided.

FIGS. 4a-4b depict an example embodiment of FIG. 2 showing the selection of a menu option twice and with haptic feedback provided.

FIG. 5 illustrates an example embodiment comprising peripheral input and output devices.

FIGS. 6a-6b depict an example embodiment of FIG. 5 showing the selection of a physical key twice and with audio feedback is provided.

FIG. 7 depicts a flow diagram describing a method used to provide feedback to a user following a first and a second user input.

FIG. 8 depicts another flow diagram describing a further method used to provide feedback to a user following a first and a second user input.

FIG. 9 illustrates schematically a computer readable medium providing a program according to an embodiment of the present disclosure.

### DESCRIPTION OF EXAMPLE ASPECTS/EMBODIMENTS

Other example embodiments depicted in the figures have been provided with reference numerals that correspond to similar features of earlier described example embodiments. For example, feature number 1 can also correspond to numbers 101, 201, 301 etc. These numbered features may appear in the figures but may not have been directly referred to within the description of these particular example embodiments. These have still been provided in the figures to aid understanding of the further example embodiments, particularly in relation to the features of similar earlier described example embodiments.

Many electronic devices are configured so that a user may interact with them. That is, a user may enter commands or information into the electronic device. Such information may be provided by a user to the device via the user interacting with a graphical user interface (GUI). A GUI may allow a user to enter commands by interacting with a user interface element, which may comprise for example one or more icons, menu entries, buttons, keys, symbols, or other elements. Some of these features, if displayed on a touch-sensitive screen, may be both displayed on the screen and interacted with by the user touching the corresponding area of the screen.

It may be the case that, upon selecting a user interface element of the GUI, the user is unsure as to what he or she has really selected. This may be because the user has obscured (by, for example, his or her hand, finger or thumb) the selected user interface element when selecting it. It may be imagined that, for example, a user touches a user interface element, such as a key in a virtual keyboard, on the touch screen display of an electronic device, and is not sure as to what key or button he or she has really selected, as their finger is covering the selected key (and possibly neighbouring keys) and thus the user can no longer see the key selected. The user therefore requires some form of clear feedback so that they know what they have selected.

Some apparatuses provide visual feedback to help the user to know what element they have selected in the GUI of an electronic device. Some apparatuses employ haptic or vibratory feedback upon selecting an element in the GUI of an electronic device. However, it is still not clear to a user if they have selected a particular element once, twice, or multiple times. If the same visual feedback is provided upon selection of a user interface element, regardless of the number of consecutive times that element has been selected, then there is no obvious distinction between the feedback provided for single and multiple inputs. This also applies to haptic feedback, and since there is often a delay between an element being selected and haptic feedback being provided, clear haptic feedback regarding multiple selections is poor.

Example embodiments contained herein may be considered to provide a way of more easily and, in certain circumstances, unambiguously, indicating to the user, via the provision of clear feedback, how many interactions with a particular user interface element, such as a key, have been input to the electronic device.

For example, one embodiment may be considered to provide a way of detecting a first user input associated with a particular user interface element, the user interface element associated with performance of a particular function; in response to detecting the first user input, providing a first feedback response, the first feedback response being separate to the performance of the associated function; detecting a second user input associated with the same particular user interface element within a predetermined period of time following detection of the first user input; and in response to detecting the second user input, providing a second feedback response, the second feedback response being separate to the performance of the function associated with the second user input, and being different to the first feedback response. Essentially, different feedback is provided to the user to help show how many times they have selected a particular user interface element. In this way a user may receive clear feedback as to how many times they have selected the same user interface element. In this context, “different feedback” refers to feedback for the second (and potentially subsequent) input that is distinguishable from the feedback for the first input, rather than a different instance of the same repeated feedback (e.g. the same visual pop-up).

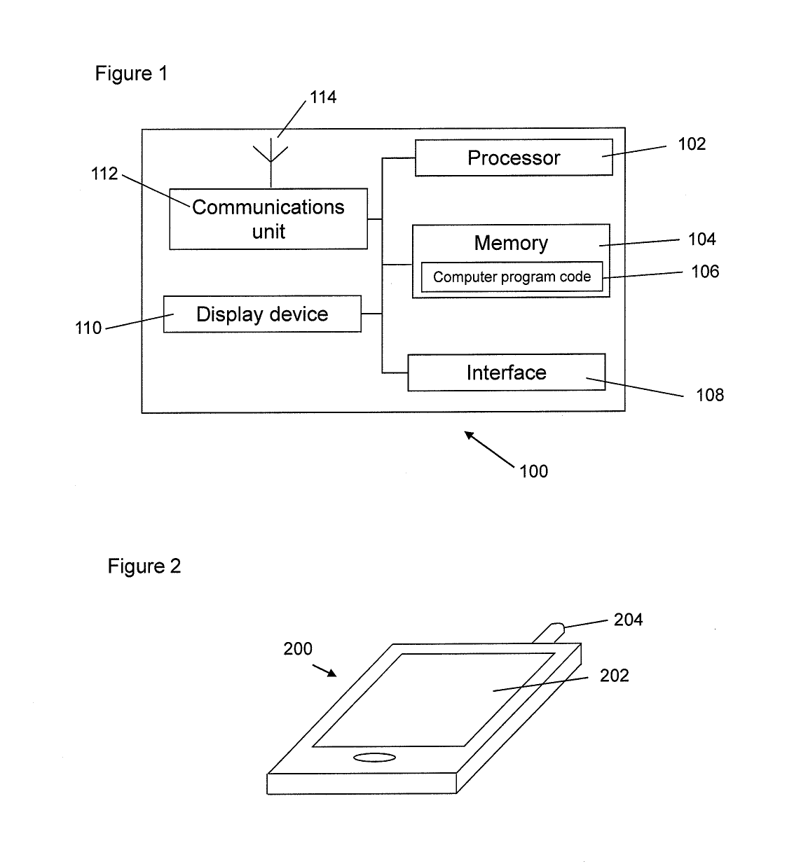

FIG. 1 depicts an apparatus (100) of an example embodiment, such as a mobile phone. In other example embodiments, the apparatus (100) may comprise a module for a mobile phone (or PDA or audio/video player), and may just comprise a suitably configured memory (104) and processor (102).

The example embodiment of FIG. 1, in this case, comprises a display device (110) such as, for example, a Liquid Crystal Display (LCD) or touch-screen user interface. The apparatus (100) of FIG. 1 is configured such that it may receive, include, and/or otherwise access data. For example, this example embodiment (100) comprises a communications unit (112), such as a receiver, transmitter, and/or transceiver, in communication with an antenna (114) for connecting to a wireless network and/or a port (not shown) for accepting a physical connection to a network, such that data may be received via one or more types of networks. This example embodiment comprises a memory (104) comprising computer program code (106) that stores data, possibly after being received via the antenna (114) or port or after being generated at the user interface (108). The processor (102) may receive data from the user interface (108), from the memory (104), or from the communication unit (112). It will be appreciated that, in certain embodiments, the display device (110) may incorporate the user interface (108). Regardless of the origin of the data, these data may be outputted to a user of apparatus (100) via the display device (110), and/or any other output devices provided with apparatus. The processor (102) may also store the data for later user in the memory (104). The memory (104) may store computer program code (106) and/or applications which may be used to instruct/enable the processor (102) to perform functions (e.g. read, write, delete, edit or process data).

FIG. 2 depicts an example embodiment of the apparatus comprising a portable electronic device (200), such as a mobile phone, a smartphone, a pocket computer, or tablet computer, a monitor, a personal digital assistant (PDA), a watch, a digital camera, or a module for one or more of the same, with a user interface comprising a touch-screen user interface (202), a memory (not shown), and a processor (not shown) and an antenna (204) (which may be external as shown or internal) for transmitting and/or receiving data (e.g. emails, textual messages, phone calls, information corresponding to web pages). The touch screen user interface comprises a virtual keyboard in some embodiments.

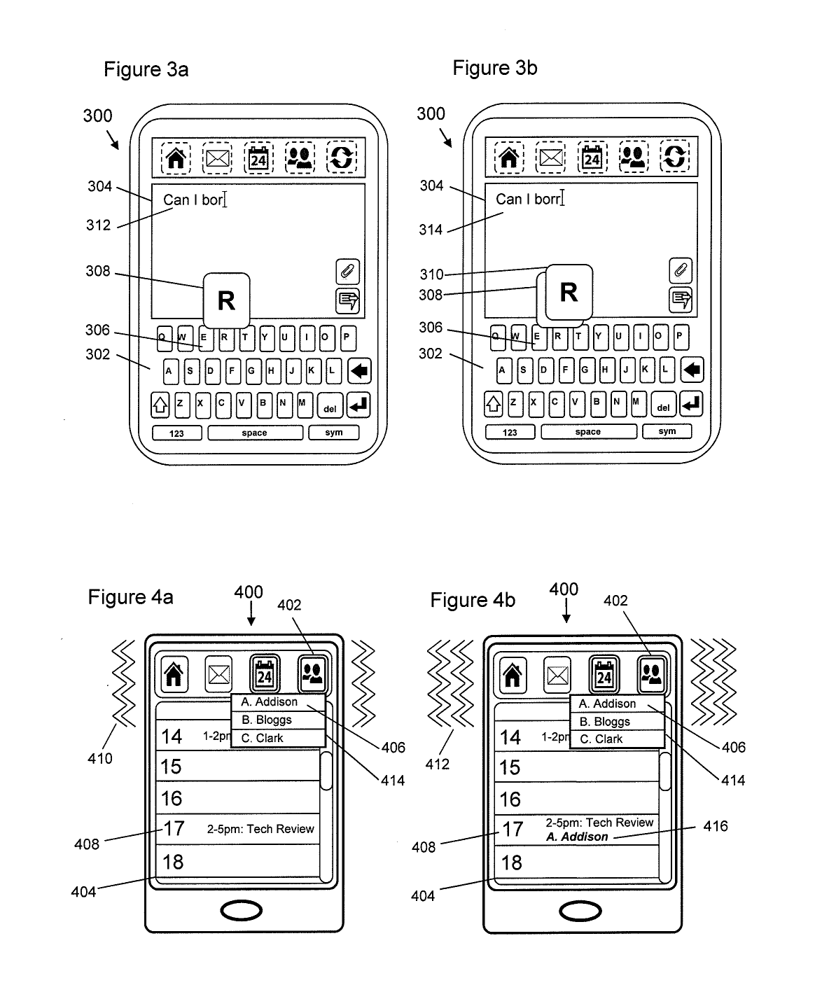

FIGS. 3a-3b illustrate two views of an example embodiment of FIG. 2 operating according to one particular example embodiment. In this example, the apparatus (300) has a touch-sensitive screen and a virtual keyboard (302) with virtual keys (306) which may be selected by a user to compose a message. Such a message may be an e-mail, SMS message, the text portion of an MMS message, text document, or other composition. The message (312, 314) appears on the message editing part of the display (304). In the following example, the user is using a portable electronic device with a touch-sensitive screen, and is using a virtual keyboard displayed on the screen to input the characters for a text message, by selecting the corresponding virtual keys, which will begin with “Can I borrow . . . ”.

In FIG. 3a, the user (not shown) has made their first user input by selecting the required particular user interface element, in this case the virtual key “R”. The particular function provided, associated with this user interface element, is that a letter “R” appears at the cursor as shown at the end of the message (312). Upon detecting the first user input, in addition to the letter “R” appearing at the cursor, the apparatus responds by providing a first feedback response, in this case a pop-up (308) showing the letter “R” above and larger than the virtual key “R”. The feedback response is positionally associated with the user interface element in that the pop-up appears immediately above the selected virtual key. In this case the first feedback response, or pop-up, is separate to the function carried out due to the user selecting the virtual key “R”, that is display of the letter “R” at the end of the composed message so far.

In this example the user is composing the word “borrow” and so the user makes a second user input (shown in FIG. 3b) which is detected by the apparatus. The user selects the same particular user interface element, i.e. the same virtual key “R”. This second user input is made within a predetermined period of time of the first user input being detected. The predetermined period of time in which to make a second user input may be 200 ms, for example. The apparatus detects this second user input and in response, provides a second feedback response (310). The second feedback response is, in this case, a pop-up showing the letter “R” above and larger than the virtual key “R”, and also partially overlapping the pop-up display shown as a first feedback response (308), such that the two pop-ups are shown together as a stack (FIG. 3b). The second feedback response is positionally associated with the user interface element in that the pop-up appears above and laterally offset to the selected virtual key such that it forms a stack with the first feedback response pop-up. This second feedback response is separate to the performance of the function associated with the second user input, which is to display the second “R” in the phrase “Can I borr” (312) shown in the message editing part of the display (304). In this way the user receives different feedback as to how many times he or she has selected a particular user interface element, in this case the letter “R”, as two pop-up displays are clearly seen.

Advantages of the different feedback provided in this way include that the user need not look away from the virtual keyboard to check the text entry region (at the top of the display in FIGS. 3a-3b). The user can maintain his or her concentration on the virtual keyboard and be clearly informed as to how many times they have selected a key, here the “R” key, in composing their chosen word, “borrow”. The pop-up appearing above the selected virtual key is easily seen by the user as their attention is already focussed on the virtual key they are selecting. By the second pop-up appearing as described, partially overlapping the first pop-up, the user is made aware unambiguously and clearly, that they really have selected the “R” virtual key twice. The user may trust that they are inputting the correct number of the required characters by concentrating only on the virtual key being pressed and the area immediately above their finger where the pop-up appears. As the user may become accustomed to entering text quickly for such messages, this unambiguous feedback is valuable as the user will not waste time or lose concentration by looking away from the virtual keyboard area to check their input has been registered correctly.

In another example embodiment (not shown in the figures) the second feedback response may be the same pop-up as the first feedback response, or a different pop-up to the first feedback response, but showing the letters “RR” to show that the virtual key “R” was selected twice. In another example embodiment (also not shown in the figures) the second feedback response may be a pop-up showing the text “R×2” to show that the virtual key “R” was selected twice. In another example embodiment (also not shown in the figures) the second feedback response may be a pop-up which is a different colour, or shape, or size, or style, or a combination thereof, to the first feedback response pop-up. In these embodiments, where the information displayed on the second pop-up is different to that displayed on the first pop-up, the second pop-up may partially overlap the first pop-up to form a stack, or may be positioned partially or entirely over the first pop-up. Other possible information displayed on the pop-up displayed as a second feedback response may be envisaged and is included in the scope of this disclosure.

In another example embodiment (not shown in the figures) the feedback response, such as an image of the virtual key, letter, symbol, icon, or other user interface element selected, may be displayed in a separate region of the display to the user interface elements, and different to the region of the display (304) showing the performance of the function. This separate region of the display may or may not be dedicated to the display of feedback responses. It will also be appreciated that the feedback may be displayed in other ways, such as an image of the virtual key, letter, symbol, icon, or other user interface element selected appearing as a background image to a part of the display, for example as a background image to the virtual keyboard (302) or to the message editing part of the display (304).

FIGS. 4a-4b illustrate a further example embodiment. This example embodiment is similar to that shown in FIGS. 3a-3b in that it relates to a portable device with a touch-sensitive screen. However, in this example, the touch-sensitive screen does not display a virtual keyboard, but instead shows a series of icons, a menu listing menu entries, and an open application. In the example shown in FIGS. 3a-3b the user wishes to enter text. In the example shown in FIGS. 4a-4b, the user wishes to select a menu entry.

Specifically in this example, the apparatus (400) is a portable computing device which has a touch-sensitive screen (404), and can display icons (402) with various possible functions associated with them. Possible functions may be to direct the user back to the home screen of the device, to open a message or email editing screen, to display a calendar screen, to display a list or database of contacts, or other function. The example device in this example is also configured to provide haptic feedback.

In this example, the apparatus has a calendar function displayed on the touch-sensitive screen (404), and it is possible to associate a contact whose details are saved in the contacts list of the apparatus with a particular calendar entry (408), for example if this contact person is attending a meeting shown in the calendar. In this particular example, the contact list may be displayed by selecting the contacts icon (402), and by selecting the name of the contact twice, i.e. the required menu item, within a predetermined period of time, the contact can be associated with a particular calendar entry.

In this example the user wishes to associate a contact, “A. Addison”, whose details are saved in the contacts list of the apparatus, with a particular calendar entry (408). The name “A. Addison” is displayed in a menu (414) as a menu item (406).

In FIGS. 4a and 4b, the calendar function is already displayed on screen, as is the menu providing a list of contacts. In FIG. 4a the user (not shown) has made their first user input by selecting the required particular user interface element, in this case the menu item “A. Addison” (406). The particular function provided, associated with this user interface element, is that the user name is selected. Upon detecting the first user input, in addition to the entry “A. Addison” being selected, the apparatus responds by providing a first feedback response, in this case a haptic or vibratory response (410). This first feedback response, or haptic response, is separate to the function carried out due to the user selecting the menu item.

This single selection of a menu item via a single user input may be a desired step in performing a certain action or may, for example, display further options or details of the contact. However, in this example, the user wishes to associate the contact name with a calendar entry by selecting the name of the contact twice within a predetermined period of time.

Thus, as shown in FIG. 4b, the user makes a second user input, i.e. selects “A. Addison” again, within a predetermined period of time, and the selection is detected by the apparatus. The predetermined period of time in which to make a second user input may be 200 ms, for example. The apparatus detects this second user input which is associated with the same particular user interface element, the menu item “A. Addison” (406), and in response, provides a second feedback response (412). The second feedback response is, in this case, a different haptic feedback response to the first haptic feedback response. The second feedback response, a haptic signal, is separate to the performance of the function associated with the second user input; that of associating the contact “A. Addison” with a calendar entry (408, 416), and the second feedback response (412) is different to the first feedback response (410).

The haptic signal provided as a second feedback response (412) may be a longer duration vibration than the haptic signal provided as first feedback response (410). The second feedback response (412) may consist of two short vibrations whereas the haptic signal provided as first feedback response (410) may consist of only one short vibration. Other possible haptic feedback responses provided as first and second feedback responses are possible, such as prolonged or stronger vibrations, and are included within the scope of the disclosure. In this way the user receives different feedback as to how many times he or she has selected the user interface element, in this case the menu item “A. Addison” (414). In this example the menu item “A. Addison” has been associated with a calendar entry (416).

Advantages of the above example are that, again, the user receives differentiating feedback that the menu item has been selected twice within a predetermined period of time to perform the desired action, that the menu item is associated with a calendar entry. The user receives a haptic feedback response to indicate that the desired input has been made without the user needing to check down the calendar displayed on screen and check that the menu item has been associated with the calendar entry. One may imagine that this would be particularly useful if several menu items were to be associated with the same calendar entry, for example if several contacts listed in the device contact list were attending the meeting shown in the calendar. Rather than the user having to check the calendar entry each time, and possibly having to read small text, or scroll around in a small area (the calendar entry area) to look at all the menu items connected to that calendar entry, the user can be confident that each double-selected menu item has been associated with the calendar entry as they will receive a different haptic feedback response for each selection and association made. It may also be envisaged that such a system may additionally employ the use of audio feedback as described in the following example for further clear and unambiguous feedback for the user.

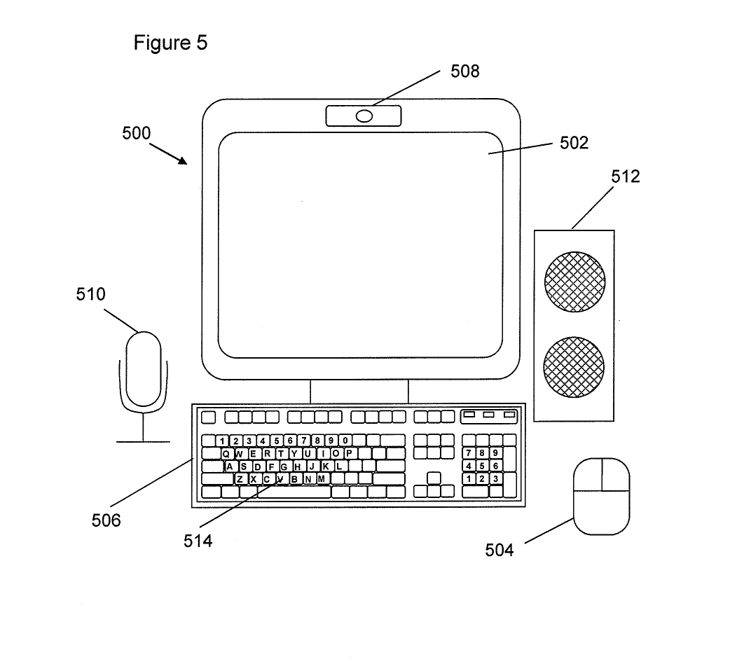

FIG. 5 depicts an example embodiment of the apparatus comprising an electronic device (500), e.g. such as a desktop computer or laptop with a user interface comprising a display or monitor (502), and user input devices, which could include a mouse (504), physical keyboard (506) with physical keys (514), a webcam (508), a microphone (510), and output devices including a speaker (512). Other possible user input devices not shown in FIG. 5 include a wand, a pointing stick, a touchpad, a joystick, a remote controller, a button, a motion detector, a position detector, a scriber, or an accelerometer.

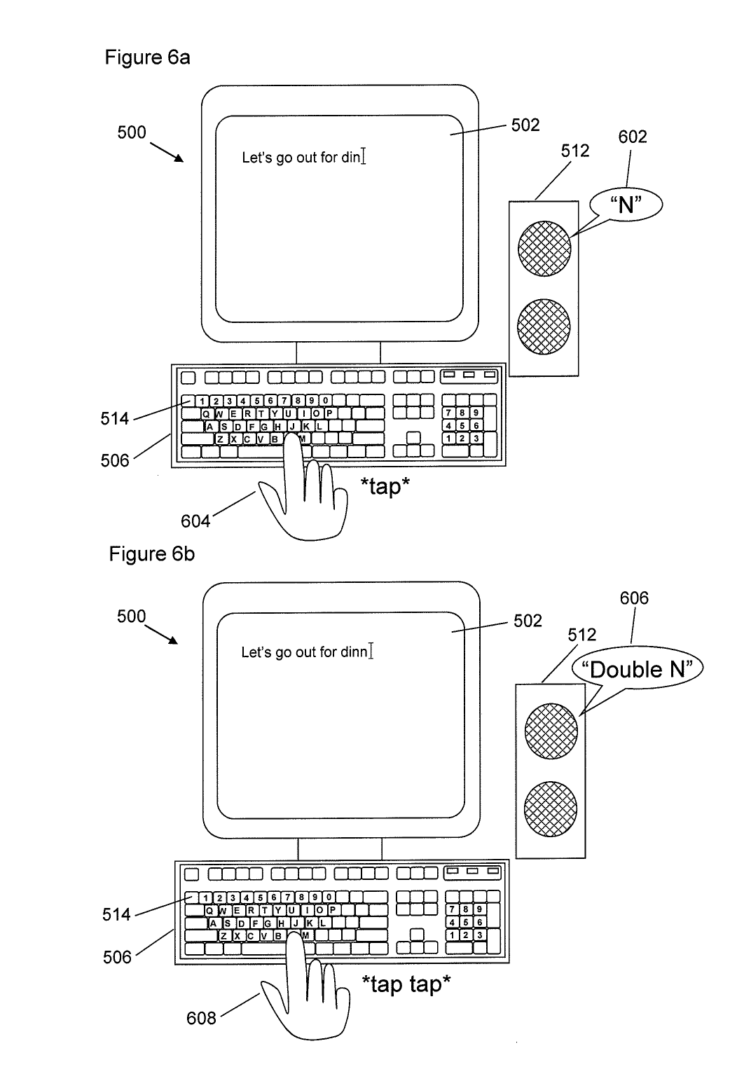

FIGS. 6a-6b illustrate two views of an example embodiment of FIG. 5. This example is different to those shown in FIGS. 3a-3b and 4a-4b, as this example relates to a device such as a desktop or laptop computer with a physical, rather than a virtual, keyboard as shown in FIGS. 3a-3b (no keyboard is shown in FIGS. 4a-4b; that is not to say a virtual keyboard could not be displayed or that an external physical keyboard could not be connected). The device in the example shown in FIG. 6a-6b is configured to provide audio feedback via a speaker; the other examples in FIGS. 3a-3b and 4a-4b above may also be equipped with audio output capabilities through built-in speakers, or through external speakers which may be connected to the electronic devices. In this example, the apparatus is an electronic device (500) such as a desktop computer or laptop with a user interface comprising a monitor (502), and a physical keyboard (506) with physical keys (514) as user interface elements. In FIG. 6a the user (604) has made their first user input by selecting the required particular user interface element, here a physical key (514), the “N” key in this case, and tapping it once. The particular function provided, associated with this user interface element, is that a letter “N” appears at the cursor as shown at the end of the message “Let's go out for din” displayed on the monitor (502). Upon detecting the first user input, in addition to the letter “N” appearing at the cursor, the apparatus responds by providing a first feedback response, in this case an audio feedback response of the letter “N” being recited (602) to the user via a speaker (512). This first feedback response is audibly associated with the user interface element in that it is reciting the input made, by reciting the letter “N”. This first feedback response of an audio feedback response is separate to the function carried out due to the user selecting the physical key “N”, which is the display of the letter “N” at the end of the composed message so far.

In this example the user is composing the word “dinner” in the phrase “Let's go out for dinner” and so the user makes a second user input (shown in FIG. 6b) which is detected by the apparatus. The user selects the same particular user interface element, i.e. the same physical key “N” (608). This second user input is made within a predetermined period of time of the first user input being detected. The predetermined period of time in which to make a second user input may be 200 ms, for example. The apparatus detects this second user input and in response, provides a second feedback response (606). The second feedback response is, in this case, a different audio feedback response to that made in response to the first user input. In response to the second user input the phrase “Double N” is recited (606) to the user via a speaker (512). This second feedback response is audibly associated with the user interface element in that it is reciting the input made overall within the predetermined period of time, by reciting that the letter “N” has been tapped twice, by reciting “Double N”.

It will be appreciated that it is possible for other phrases or audio signals to be recited to the user, for example as feedback responses, such as “N N”, “N twice”, “N times two”, or it may be that the second feedback response is louder than the first feedback response, or a tone or tune may play, or a combination thereof is possible. For example, the first feedback response may comprise a musical note of a first pitch, and the second feedback response could comprise a second musical note with a second, possibly higher pitch, to signal to the user a second input. Other audio feedback responses, where the second response is different to the first, may be envisaged and are included within the scope of the disclosure.

The second feedback response is separate to the performance of the function associated with the second user input, which is to display the second “N” in the phrase “Let's go out for dinn” shown on the monitor (502). In this way the user receives clear differentiating feedback as to how many times he or she has selected a particular user interface element, in this case the letter “N”, as a different audio response is given for the second user input to the first user input.

This example provides the advantage to the user that touch-typing (typing a message using a physical keyboard such as that (506) shown in FIG. 5) may be made easier as the user receives differentiating feedback as to the keys pressed without having to look at the keyboard. For example, if the user is typing in some text which has been written on a separate piece of paper, then their attention may remain on the piece of paper with the written notes, and they will be made aware of the keys being pressed by the audio feedback without having to move their attention either to the keyboard or to the monitor displaying the entered text. This example may also provide advantages for visually-challenged users who may not be able to see the monitor and/or keyboard clearly, or at all. These users will be aware of the keys they are selecting, and particularly of multiple subsequent presses of the same key, due to the differentiating and in some cases unambiguous audio feedback provided.

In further example embodiments it may be envisaged that the user may wish to select a particular user element more than twice, for example in a word containing a string of more than two of the same character such as in the phrase “This is soooo exciting!”, or to type “xxx” at the end of a message to a friend. In this case, the apparatus may detect one or more subsequent user inputs associated with the same particular user interface element, such as tapping the “x” key for a second/third time, with a respective predetermined period of time following detection of the previous user input i.e. detection of the first/second “x”. In response to detecting this subsequent user input, the apparatus can provide a subsequent feedback response, the subsequent feedback response being separate to the performance of the function associated with the subsequent user input (the second/third “x” input), and being different to the immediately preceding feedback response. The subsequent feedback response may be, for example, a third pop-up appearing partially overlapping the second pop-up in a stack of pop-ups (408, 410) to display a larger stack of pop-ups, a third haptic feedback response or vibration following a second haptic feedback response or vibration (414), or an audio feedback response to the user indicating a third key touch, i.e. a phrase is recited such as “X X X”, “X three times”, “Triple X”. It will be appreciated that other possible subsequent feedback responses are possible and included within the scope of the disclosure.

It will be appreciated that a said user interaction may be a combination of one or more gestures, e.g. single or multiple taps or clicks, a swipe, a rotate gesture, an extended input or a multi-touch gesture. For example, the user could tap a user interface element such as a virtual key (406) once to type a letter and then maintain a touch/hold on the same virtual key (406) a second time within a predetermined period of time to execute a different action, such as inputting the letter as a capital rather than a smaller case letter, or input a number associated with that virtual key, or include an accent on a letter already inputted on the first selection of the virtual key. As a further example, a user could click or tap once on a user interface element such as a menu item (406), then swipe to drag the menu item to a different area on the display such as over a calendar entry to associate that menu item with the calendar entry (408, 416). As a further example, the user may tap an item on a touch-sensitive display with a single finger as a first input, and then with two fingers together as a second input, to perform a particular function. Other examples are possible and included in the scope of the disclosure.

It will be appreciated that a combination of different types of feedback response may be provided. It will also be appreciated that a combination of multiple feedback responses may be provided, For example, a first feedback response of a pop-up may be followed by a second feedback response of a second pop-up plus a haptic feedback response. As a further example, a first feedback response may be an audio response plus a visual pop-up, followed by a second feedback response of a second audio response plus a second visual pop-up. All combinations of feedback responses discussed herein are possible and included within the scope of the disclosure.

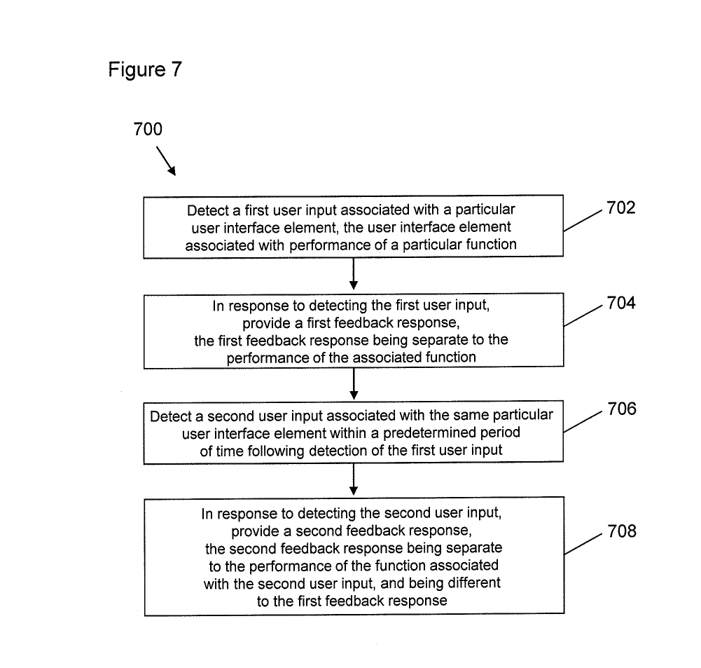

FIG. 7 shows a flow diagram illustrating a method used to provide feedback to a user following a first and second user input, and is self-explanatory.

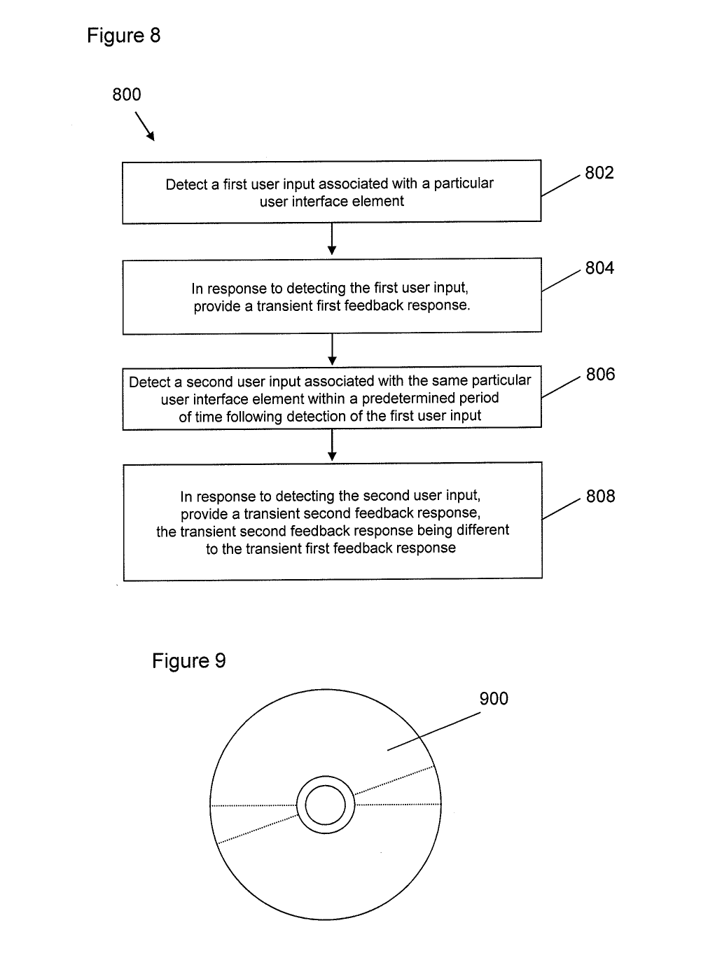

FIG. 8 shows another flow diagram further illustrating a method used to provide feedback to a user following a first and second user input. FIGS. 3a-3b are referred to again in this example. In FIG. 3a, the user (not shown) has made their first user input by selecting the required particular user interface element, in this case the virtual key “R”, and this input has been detected by the apparatus. A transient first feedback response is provided, which in this example is a pop-up (308) displaying the letter “R” above and larger than the virtual key “R”. The first feedback response is transient in that, after a finite duration, the first feedback response pop-up is no longer displayed. This is in contrast to the letter “R” added at the end of the message (312) which remains displayed as part of the message being composed. The finite duration of the transient first feedback response may be 200 ms. The finite duration may also be shorter than this, such as 100 ms, 50 ms or shorter. The finite duration of the transient first feedback response may also be longer, such as 250 ms, 500 ms, 1 s, or longer. It may be envisaged that this feedback response duration is set by the user. It may also be envisaged that this feedback response duration is preset, or that it may be determined by the apparatus in some way, perhaps by the apparatus monitoring user habits and/or accounting for user preferences.

Other possible visual feedback responses may be envisaged, as described elsewhere in this application and these may be transient, i.e. of finite duration. Other possible transient feedback responses include haptic feedback responses, which have a finite duration of vibration, or audio feedback responses, which have a finite duration in that they end after the recitation of a feedback message or after a tone, click, buzz, tune, or other sound has been played.

In the example shown in FIGS. 3a and 3b, the user is composing the word “borrow” and so the user makes a second user input (shown in FIG. 3b) which is detected by the apparatus. The user makes the same user input as before, by selecting the same user interface element, i.e. the virtual key “R”. This second user input is made within a predetermined period of time of the first user input being detected. The predetermined period of time in which to make a second user input may be 200 ms, for example. The apparatus detects this second user input and in response, provides a transient second feedback response. The transient second feedback response is different to the transient first feedback response. The transient second feedback response is, in this case, a pop-up showing the letter “R” above and larger than the virtual key “R”, and also partially overlapping the pop-up display shown as a first feedback response (308), such that the two pop-ups are shown together as a stack (FIG. 3b). The transient second feedback response has a finite duration, which, similarly to the transient first feedback response, may be 200 ms. The finite duration may also be shorter than this, such as 100 ms, 50 ms or shorter. The finite duration may also be longer, such as 250 ms, 500 ms, 1 s, or longer. It may be envisaged that this feedback response duration is set by the user. It may also be envisaged that this feedback response duration is preset, or that it may be determined by the apparatus in some way, perhaps by the apparatus monitoring user habits and/or accounting for user preferences.

In the case where the duration of the transient first feedback response is less than that of the predetermined period of time within which a second user input is made, it may be envisaged that the transient second feedback response is a pop-up showing the letter “R” above and larger than the virtual key “R” (310), partially overlapping a re-displayed representation of the first feedback response pop-up (308), such that the second feedback response has the appearance of the first and second pop-ups shown together as a stack (FIG. 3b).

Advantages of this method include those mentioned in the earlier described embodiment relating to FIGS. 3a-3b. Further, there is the advantage, for example, of the user being able to set the duration of the transient feedback responses and thus allowing enhanced user flexibility and personalisation of the feedback responses. There is also the advantage, for example, of the apparatus determining, perhaps by the apparatus monitoring user habits and/or accounting for user preferences, that the feedback responses are tailored for the user, thus enhancing the user experience by having a personalised feedback response system, without the user being required to enter any particular feedback duration settings.

Throughout the above examples the first user input and second user input (and any further inputs) are described as being separated by a predetermined period of time between inputs. It will be appreciated by the skilled person that other ways by which first and second user inputs are defined are possible. The predetermined period of time is one example of a parameter trigger that can be applied to the second user input with respect to the first user input.

The predetermined period of time may be the time between the start of contact with the user interface element in making a first user input and the start of contact with the user interface element in making the second user input. Another example is that the predetermined period of time may be the time between the release of the first user interface element (or the end of contact with the user interface element in making a first user input) and the start of contact with the user interface element in making the second user input. Another example is that the predetermined period of time may be the time between the release of the first user interface element (or the end of contact with the user interface element in making a first user input) and the release of the second user interface element, or the end of contact with the user interface element in making the second user input. Another example is that the predetermined period of time may be the time between the start of contact with the user interface element in making a first user input and the release of the second user interface element, or the end of contact with the user interface element in making the second user input.

Further ways of defining the first and second user inputs may be related to the user making the user input for different periods of time, which is an example of another parameter trigger. For example, a first user input may be made with the user contacting the user interface element (for example, a virtual key) for a particular period of time, and a second user input may be made with the user contacting the user interface element for a different particular period of time, which may be a longer, or a shorter, period of time than that taken contacting the user interface element when making the first user input.

Further ways of defining the first and second user inputs may be related to the force with which the user inputs are made, which is another example of a parameter trigger. For example, the second user input may be made using more force applied to the user interface element than that applied in making the first user input. Another example of a parameter trigger, which applies to touch-sensitive displays which can sense, for example, a finger at a distance from the display without physically contacting or pressing the display, is that if the user lifts their finger from the touch sensitive screen by a predetermined distance between making first and second user inputs, then the second input is recognised as a second input following the first user input and a second feedback response is provided accordingly, for example as described in the above examples. The predetermined distance the finger is lifted from the screen in making such input may be 2 mm. It may also be less than 2 mm, or more than 2 mm, depending on the settings of the apparatus. These apparatus settings may be preset, or may be set by the user, or may be set using some feedback system to choose a distance based on user habits. Examples of defining first and second user inputs based on a predetermined period of time between inputs, based on the length of time the user interface element is contacted for the different inputs, based on the force with which a user makes his or her inputs, or based on the distance between a suitable user interface element such as a virtual key and a user finger, may be as described or may be used independently or with each other in any combination.

FIG. 9 illustrates schematically a computer/processor readable media 900 providing a program according to one or more embodiments. In this example, the computer/processor readable media is a disc such as a digital versatile disc (DVD) or a compact disc (CD). In other embodiments, the computer readable media may be any media that has been programmed in such a way as to carry out an inventive function.

The present disclosure relates to the field of providing feedback response to a user of a electronic device, associated methods, computer programs and apparatus. Certain disclosed aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs), and tablet PCs.

The portable electronic devices/apparatus according to one or more disclosed aspects/embodiments may provide one or more audio/text/video communication functions (e.g. tele-communication, video-communication, and/or text transmission (Short Message Service (SMS)/Multimedia Message Service (MMS)/emailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

It will be appreciated to the skilled reader that any mentioned apparatus and/or other features of particular mentioned apparatus may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some example embodiments, a particular mentioned apparatus may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

It will be appreciated that the any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

It will be appreciated that any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
at least one processor; and
at least one memory including computer program code,
the at least one memory and the computer program code configured to, with the at least one processor, cause the apparatus to perform at least the following:
detect a first user input associated with a particular user interface element, the user interface element associated with performance of a particular function;
in response to detecting the first user input, provide a first feedback response, the first feedback response being separate to the performance of the associated function;
detect a second user input associated with the same particular user interface element within a predetermined period of time following detection of the first user input; and
in response to detecting the second user input, provide a second feedback response, the second feedback response being separate to the performance of the function associated with the second user input, and being different to the first feedback response.

2. The apparatus of claim 1 wherein the at least one memory and the computer program are configured to perform the function associated with the first user input and provide the separate first feedback response.

3. The apparatus of claim 1 wherein the at least one memory and the computer program are configured to perform the function associated with the second user input and provide the separate second feedback response.

4. The apparatus of claim 1 wherein the user interface element is associated with the performance of more than one particular function.

5. The apparatus of claim 1 wherein the said feedback response is configured to be positionally or audibly associated with the user interface element.

6. The apparatus of claim 1 where a said feedback response comprises a combination of one or more of: a visual feedback response, an audio feedback response, a haptic feedback response or a transient feedback response.

7. The apparatus of claim 6 wherein the visual feedback response is provided by a pop-up display.

8. The apparatus of claim 7 wherein the pop-up display shown as a second feedback response is positioned as to partially overlap the pop-up display shown as a first feedback response, such that the two pop-ups are shown together as a stack.

9. The apparatus of claim 7 wherein the visual feedback response is displayed in a separate region of the display to the user interface elements.

10. The apparatus of claim 1, wherein the apparatus is a portable electronic device, a pocket computer, a laptop computer, a desktop computer, a tablet computer, a mobile phone, a smartphone, a monitor, a personal digital assistant, a watch, a digital camera, or a module for one or more of the same.

11. The apparatus of claim 1, wherein the said user input is one or more of a tap, click, swipe, rotate gesture, multi-touch gesture, and an extended input having a duration exceeding a predetermined threshold.

12. The apparatus of claim 1 wherein the user interface element comprises a combination of one or more of: a physical key, a virtual key, a menu item, an icon, a button, and a symbol.

13. The apparatus of claim 1, wherein the user interface element forms part of a user interface, and wherein the user interface comprises a combination of one or more of a wand, a pointing stick, a touchpad, a touch-screen, a stylus and pad, a mouse, a physical keyboard, a virtual keyboard, a joystick, a remote controller, a button, a microphone, a motion detector, a position detector, a scriber and an accelerometer.

14. The apparatus of claim 1 wherein the apparatus is configured to:
detect one or more subsequent user inputs associated with the same particular user interface element within respective predetermined periods of time following detection of the previous user input; and
in response to detecting the subsequent user input, provide a subsequent feedback response, the subsequent feedback response being separate to the performance of the function associated with the subsequent user input, and being different to the immediately preceding feedback response.

15. A method comprising:
detecting a first user input associated with a particular user interface element, the user interface element associated with performance of a particular function;
in response to detecting the first user input, providing a first feedback response, the first feedback response being separate to the performance of the associated function;
detecting a second user input associated with the same particular user interface element within a predetermined period of time following detection of the first user input; and
in response to detecting the second user input, providing a second feedback response, the second feedback response being separate to the performance of the function associated with the second user input, and being different to the first feedback response.

16. An apparatus comprising:
at least one processor; and
at least one memory including computer program code,
the at least one memory and the computer program code configured to, with the at least one processor, cause the apparatus to perform at least the following:
detect a first user input associated with a particular user interface element;
in response to detecting the first user input, provide a transient first feedback response;
detect a second user input associated with the same particular user interface element within a predetermined period of time following detection of the first user input; and
in response to detecting the second user input, provide a transient second feedback response, the transient second feedback response being different to the transient first feedback response.
